(19) United States
(12) Patent Application Publication
(10) Pub. No.: US 2026/0131310 A1
(43) Pub. Date: May 14, 2026

(54) MONOLITHIC SUBSTRATES

(71) Applicant: CORNING INCORPORATED, CORNING, NY (US)

(72) Inventors: Willard Ashton Cutler, Elmira, NY (US); Jia Liu, Painted Post, NY (US)

(21) Appl. No.: 19/119,291

(22) PCT Filed: Oct. 9, 2023
(86) PCT No.: PCT/US2023/034717

§ 371 Date: Apr. 8, 2025

Related U.S. Application Data
(60) Provisional application No. 63/417,725, filed on Oct. 20, 2022.

(51) Int. Cl. B01J 20/28; B01D 53/04; B01J 20/04; B01J 20/20; B01J 20/30; B01J 20/32; B01J 20/34

(52) U.S. Cl. CPC B01J 20/28045; B01D 53/0454; B01J 20/043; B01J 20/20; B01J 20/28011; B01J 20/2803; B01J 20/3007; B01J 20/3078; B01J 20/3204; B01J 20/324; B01J 20/3433; B01J 20/3441; B01D 2253/102; B01D 2253/3425; B01D 2257/504

(57) ABSTRACT

A monolithic substrate includes a dried and/or cured product of an extruded extrudable paste. The extrudable paste includes a hollow and/or porous material. The extrudable paste also includes a binder. The monolithic substrate has a bulk density of 60 g/L to 170 g/L.

### CROSS-REFERENCE TO RELATED APPLICATIONS

This application claims the benefit of priority under 35 U.S.C. § 119 of U.S. Provisional Application No. 63/417,725 filed Oct. 20, 2022, the content of which is incorporated herein by reference in its entirety.

### BACKGROUND

Climate change is a growing concern. Globally there is a need to reduce the CO₂ footprint, either by finding alternatives for processes that generate CO₂ or by capturing the released CO₂ at the point source or in ambient air. Negative emission technologies for removing CO₂ include aforrestation, reforestation, direct air capture (e.g., removing CO₂ from ambient air), and bioenergy with carbon capture and storage (BECCS).

One method of removing CO₂, either from a point source or from ambient air includes flowing the CO₂ laden stream through a monolith containing a sorbent that adsorbs the CO₂. The CO₂ can later be desorbed for removal (e.g., via heating of the monolith). However, the CO₂ removal of conventional monoliths can be constrained by the bulk density of the monolith (heat capacity) requiring more energy to heat for CO₂ desorption. The CO₂ removal efficiency can be further constrained limiting the amount of sorbent that can be added to the monolith. The mechanical strength of the monolith material also plays a role in the monolith's ability to survive subsequent processing steps including application of the sorbent, installation of the monolith into the system, and rejuvenation processing including removal of the monolith strip spent sorbent and reapplication of new sorbent. Mechanical strength of monoliths can depend on features such as the number and thickness of walls of the structure, all of which are factors in the density or heat capacity of the resulting monolith.

### SUMMARY OF THE INVENTION

In various aspects, the present invention provides a monolithic substrate including a dried and/or cured product of an extruded extrudable paste. The extrudable paste includes a hollow and/or porous material. The extrudable paste also includes a binder. The monolithic substrate has a bulk density of 60 g/L to 170 g/L.

In various aspects, the present invention provides a monolithic substrate including a dried and cured product of an extruded extrudable paste. The extrudable paste includes a hollow and/or porous material including hollow glass beads, hollow plastic beads, hollow glass ceramic beads, hollow ceramic beads, cenospheres, fly ash-based hollow beads, other hollow or porous particles, or a combination thereof. The extrudable paste also includes a binder including a polymer, an inorganic binder, a thermosetting resin, or a combination thereof. The monolithic substrate has a bulk density of 60 g/L to 170 g/L and an open frontal area of 80-95%.

In various aspects, the present invention provides a method of forming the monolithic substrate of the present invention. The method includes extruding the extrudable paste. The method also includes drying and/or curing the extruded extrudable paste.

In various aspects, the present invention provides a method of using the monolithic substrate of the present invention. The method includes exposing monolithic substrate to a gas stream including CO₂ to at least partially adsorb the CO₂ from the gas stream into a coating on the monolithic substrate, the coating including a material that adsorbs and desorbs CO₂. The method also includes desorbing the CO₂ from the coating on the monolithic substrate.

In various aspects, the present invention provides a carbonized monolithic substrate that includes a carbonized product of the monolithic substrate of the present invention.

In various aspects, the present invention provides a carbonized monolithic substrate that includes a dried, cured, and carbonized product of an extruded extrudable paste. The extrudable paste includes a hollow and/or porous material including hollow glass beads, hollow plastic beads, hollow glass ceramic beads, hollow ceramic beads, cenospheres, fly ash-based hollow beads, or a combination thereof. The extrudable paste also includes a binder including a polymer, an inorganic binder, a thermosetting resin, or a combination thereof. The carbonized monolithic substrate has a bulk density of 60 g/L to 170 g/L and an open frontal area of 80-95%.

In various aspects, the present invention provides a method of forming the carbonized monolithic substrate of the present invention. The method includes carbonizing the monolithic substrate of the present invention. In various aspects, the carbonized monolithic substrate can be electrically conductive.

In various aspects, the present invention provides a method of using the carbonized monolithic substrate of the present invention. The method includes exposing carbonized monolithic substrate to a gas stream including CO₂ to at least partially adsorb the CO₂ from the gas stream into a coating on the carbonized monolithic substrate, the coating including a material that adsorbs and desorbs CO₂. The method also includes desorbing the CO₂ from the coating on the carbonized monolithic substrate.

In various aspects, the present invention provides a carbonized and activated monolithic substrate that includes a carbonized and activated product of the monolithic substrate of the present invention.

In various aspects, the present invention provides a carbonized and activated monolithic substrate that includes a dried, cured, carbonized, and activated product of an extruded extrudable paste. The extrudable paste includes a hollow and/or porous material including hollow glass beads, hollow plastic beads, hollow glass ceramic beads, hollow ceramic beads, cenospheres, fly ash-based hollow beads, or a combination thereof. The extrudable paste includes a binder including a polymer, an inorganic binder, a thermosetting resin, or a combination thereof. The extrudable paste also includes a sorbent, sorbent aid, sorbent precursor, and/or sorbent aid precursor, the sorbent aid including Al₂O₃, TiO₂, SiO₂, or a combination thereof, the sorbent comprising a zeolite, sodium carbonate, activated carbon, carbon nanotubes, a metal-organic framework (MOF), an amine, or a combination thereof, and the sorbent precursor and/or sorbent aid precursor including an Al₂O₃ precursor, a TiO₂ precursor, an SiO₂ precursor, or a combination thereof. The carbonized and activated monolithic substrate has a bulk density of 60 g/L to 170 g/L and an open frontal area of 80-95%.

In various aspects, the present invention provides a method of forming the carbonized and activated monolithic substrate of the present invention. The method includes activating the carbonized monolithic substrate of the present invention.

In various aspects, the present invention provides a method of using the carbonized and activated monolithic substrate of the present invention. The method includes exposing the carbonized and activated monolithic substrate to a gas stream including CO₂ to at least partially adsorb the CO₂ from the gas stream into a coating on the carbonized and activated monolithic substrate, the coating including a material that adsorbs and desorbs CO₂. The method also includes desorbing the CO₂ from the coating on the carbonized and activated monolithic substrate.

In various aspects, the monolith of the present invention (e.g., monolith, carbonized monolith, and/or carbonized and activated monolith) and method of making and using the same can have certain advantages over other monoliths and methods of making and using the same. For example, in various aspects, the monolith, carbonized monolith, and/or carbonized and activated monolith of the present invention can have a lower mass per area (e.g., from thinner walls and/or higher porosity), and/or a lower thermal mass (i.e., requiring less energy per mass to heat), as compared to other monoliths for CO₂-removal. In various aspects, the monolith, carbonized monolith, and/or carbonized and activated monolith of the present invention can have an extruded shape that is not possible to generate with other monoliths (e.g., a geometry with thinner walls and/or greater porosity), such as with cordierite monoliths, such as due to enhanced mechanical strength and or reduced density prior to or after hardening. In various aspects, the monolith, carbonized monolith, and/or carbonized and activated monolith of the present invention can have a higher surface area per volume than other monoliths, such as compared to monoliths prepared from cordierite materials, allowing for more efficient capture of CO₂. In various aspects, the higher surface area per volume enables placement of a greater surface area of sorbent coating per volume on the monolith, carbonized monolith, and/or carbonized and activated monolith of the present invention, as compared to other monoliths, enabling more efficient CO₂-removal.

In various aspects, the monolith, carbonized monolith, and/or carbonized and activated monolith of the present invention can include a sorbent, sorbent aid, sorbent precursor, and or sorbent aid precursor incorporated therein and/or coated thereon, such that the monolith, carbonized monolith, and/or carbonized and activated monolith of the present invention has a high surface area, greater adsorptive properties, or a combination thereof. In various aspects, the monolith, carbonized monolith, and/or carbonized and activated monolith of the present invention can have a lower pressure drop than other monoliths, such as compared to monoliths prepared from cordierite materials. In various aspects, the monolith, carbonized monolith, and/or carbonized and activated monolith of the present invention can be produced at lower cost than other monoliths of similar size, such as compared to monoliths prepared from cordierite materials.

### BRIEF DESCRIPTION OF THE FIGURES

The drawings illustrate generally, by way of example, but not by way of limitation, various aspects of the present invention.

FIG. 1 is a photograph illustrating two pastes made using various recipies, in accordance with various aspects.

FIG. 2 is a photograph of sheets rolled and cured from two pastes at two different thicknesses, in accordance with various aspects.

FIG. 3 is a photograph of illustrating sheets rolled and cured from two pastes floating in water, in accordance with various aspects.

FIG. 4 is a SEM image showing a cross-section of a rolled and cured sheet, in accordance with various aspects.

FIG. 5 is a photograph showing side and top views of an extruded honeycomb monolith, in accordance with various aspects.

FIG. 6 is a photograph showing side and top views of an extruded honeycomb monolith that has been carbonized, in accordance with various aspects.

FIG. 7 is a photograph showing side and top views of an extruded honeycomb monolith that has been carbonized, in accordance with various aspects.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

### Monolithic Substrate.

In various aspects, the present invention provides a monolithic substrate. The monolithic substrate includes a dried and/or cured product of an extruded extrudable paste. The extrudable paste can include a hollow and/or porous material. The extrudable paste can also include a binder. The monolithic substrate can have a bulk density of 60 g/L to 170 g/L.

The extrudable paste can be a homogeneous composition. The binder can include any suitable binder. The binder can include an inorganic binder, a polymer (e.g., a cross-linkable polymer), a thermosetting resin, a carbon precursor (e.g., any suitable carbonizable binder), or a combination thereof. The binder can include a phenolic resin. The binder can form any suitable proportion of the extrudable paste. For example, the binder can be 10 wt % to 80 wt % of the paste, or 30 wt % to 50 wt %, or less than or equal to 80 wt % and greater than or equal to 10 wt %, 15, 20, 25, 30, 35, 40, 45, 50, 55, 60, 65, 70, or 75 wt % of the paste.

The hollow and/or porous material can include any suitable material that is hollow, porous, or a combination thereof. The hollow and/or porous material can be a particulate material. The hollow and/or porous material can include an organic and/or inorganic material. The hollow and/or porous material can include paper, polymer, glass, glass ceramic, ceramic, or a combination thereof. The hollow and/or porous material can include hollow glass beads, hollow plastic beads (e.g., polystyrene or polypropylene), hollow glass ceramic beads, hollow ceramic beads, cenospheres, fly ash-based hollow beads, or a combination thereof. The hollow and/or porous material can be a particulate material having a particle size (e.g., number average particle average) of 0.1 microns to 500 microns, or 0.1 microns to 100 microns, or 10 microns to 200 microns, or less than or equal to 500 microns and greater than or equal to 0.1 microns, 0.5, 1, 2, 4, 6, 8, 10, 20, 30, 40, 50, 60, 80, 100, 120, 140, 160, 180, 200, 250, 300, 350, 400, or 450 microns. The hollow and/or porous material can form any suitable proportion of the extrudable paste, such as 5 wt % to 70 wt %, 10 wt % to 50 wt %, 25 wt % to 35 wt %, or less than or equal to 70 wt % and greater than or equal to 5 wt %, 10, 15, 20, 25, 30, 35, 40, 45, 50, 55, 60, or 65 wt %.

In various aspects, the monolithic substrate includes a sorbent and/or sorbent aid. The sorbent and/or sorbent aid can be included as part of the extrudable paste prior to the extrusion thereof, and/or can be added to the monolith after extrusion of the extrudable paste, such as before or after curing and/or drying. The sorbent aid can enable the monolithic substrate, and/or a carbonized monolithic substrate and/or a carbonized activated monolithic substrate derived therefrom, to have a higher surface area. The sorbent can enable the monolithic substrate, and/or a carbonized monolithic substrate and/or a carbonized activated monolithic substrate derived therefrom, to have enhanced adsorptive properties. The sorbent aid can include Al₂O₃, TiO₂, SiO₂, or a combination thereof. The sorbent can include a zeolite, sodium carbonate, activated carbon, carbon nanotubes, a metal-organic framework (MOF), an amine, or a combination thereof.

In various aspects, the monolithic substrate includes a sorbent precursor and/or a sorbent aid precursor. The sorbent precursor and/or sorbent aid precursor can be included as part of the extrudable paste prior to the extrusion thereof, and/or can be added to the monolith after extrusion of the extrudable paste, such as before or after curing and/or drying. The sorbent precursor and/or sorbent aid precursor can enable a carbonized monolithic substrate and/or a carbonized activated monolithic substrate derived therefrom, to have a high surface area. The sorbent precursor and/or sorbent aid precursor can transform to a sorbent or sorbent aid during carbonization and/or subsequent activation of the monolith. The sorbent precursor and/or sorbent aid precursor can include an Al₂O₃ precursor, a TiO₂ precursor, an SiO₂ precursor, or a combination thereof. The sorbent precursor and/or sorbent aid precursor can include aluminum isopropoxide, titanium ispropoxide, titanium butoxide, tetraethoxysilane, tetrabutoxysilane, or a combination thereof.

The monolithic substrate can include sorbent, sorbent aid, sorbent precursor, sorbent aid precursor, or a combination thereof. A weight ratio of the sorbent, sorbent aid, sorbent precursor, sorbent aid precursor, or a combination thereof, to the hollow and/or porous material, can be any suitable ratio, such as 0.01:1 to 2:1, or 0.1:1 to 1:1, or less than or equal to 2:1 and greater than or equal to 0.01:1, 0.05:1, 0.1:1, 0.2:1, 0.3:1, 0.4:1, 0.5:1, 0.6:1, 0.7:1, 0.8:1, or 0.9:1. The sorbent, sorbent aid, sorbent precursor, sorbent aid precursor, or combination thereof can be 0.001 wt % to 10 wt % of the extrudable composition, or 0.01 wt % to 5 wt %, or less than or equal to 10 wt % and greater than or equal to 0.001, 0.005, 0.01, 0.05, 0.1, 0.5, 1, 2, 3, 4, 5, 6, or 8 wt %.

The extrudable paste can optionally include a viscosity modifier, such as a cellulose derivative. The cellulose derivative can be a methylcellulose derivative, such as a methylcellulose and/or hydroxypropyl methylcellulose polymer. The viscosity modifier can be 1 wt % to 15 wt %, or 3 wt % to 10 wt %, of the extrudable paste.

The extrudable paste can optionally include sodium stearate. The sodium stearate can be 0.1-3 wt %, or 0.1-1 wt %, of the extrudable paste.

The extrudable paste includes a solvent. The solvent can be any suitable solvent, such as an organic solvent or an aqueous solvent. The solvent can be water. The solvent can form any suitable proportion of the extrudable paste, such as 5 wt % to 50 wt %, or 10 wt % to 40 wt %, or less than or equal to 50 wt % and greater than or equal to 5 wt %, 6, 8, 10, 12, 14, 16, 18, 20, 22, 24, 26, 28, 30, 32, 34, 36, 38, 40, 42, 44, 46, or 48 wt %.

The dried and/or cured product of the extruded extrudable paste can be a dried product of the extruded extrudable paste, a cured product of the extruded extrudable paste, or product of both drying and curing the extrudable paste. The drying and/or curing can be any suitable drying or curing. The drying can include heating and/or allowing to dry. The curing can include heating. The drying and curing can occur during a single step, or the drying and the curing can be performed as discrete heating steps. In various aspects, the drying and/or curing includes heating at a temperature in a range of 50° C. to 400° C. (e.g., less than or equal to 400° C. and greater than or equal to 50° C., 60, 80, 100, 120, 140, 160, 180, 200, 220, 240, 260, 280, 300, 320, 340, 360, or 380° C.) for a duration of 1 min to 2 h (e.g., less than or equal to 2 h and greater than or equal to 1 min, 10, 20, 30, 40, 50 min, 1 h, 1.2, 1.4, 1.6, or 1.8 h.

The monolithic substrate can have any suitable bulk density. Bulk density is the mass of the substrate divided by the total volume that the substrate occupies, wherein the total volume the substrate occupies includes particle volume, inter-particle void volume, and internal pore volume. For example, the monolithic substrate can have a bulk density of 60 g/L to 170 g/L, 80 g/L to 140 g/L, 80 g/L to 120 g/L, or less than or equal to 170 g/L and greater than or equal to 60 g/L, 65, 70, 72, 74, 76, 78, 80, 82, 84, 86, 88, 90, 92, 94, 96, 98, 100, 102, 104, 106, 108, 110, 112, 114, 116, 118, 120, 122, 124, 126, 128, 130, or 135 g/L.

Prior to curing and drying, the extrudable paste can have any suitable bulk density, such as a density of less than 1000 g/L, such as less than 1000 g/L and greater than or equal to 200 g/L, 250, 300, 350, 400, 450, 500, 550, 600, 650, 700, 750, 800, 820, 840, 860, 880, 900, 920, 940, 960, 980, or 990 g/L.

When extruded horizontally into a shape of the monolithic substrate, the extrudable paste can span a gap with no support without slumping or deforming, the gap having a distance in a range of 0.1 m to 10 m, or less than or equal to 10 m and greater than or equal to 0.1 m, 0.2, 0.3, 0.4, 0.5, 0.6, 0.7, 0.8, 0.9, 1, 1.2, 1.4, 1.6, 1.8, 2, 2.5, 3, 3.5, 4, 4.5, 5, 6, 7, 8, or 9 m.

In various aspects, the dried and/or cured product of the extruded extrudable paste can be conductive, such that the monolithic substrate is conductive. The conductivity of the monolithic substrate can be sufficient to allow the monolithic substrate to be resistively heated by flowing electricity therethrough. In various aspects, such resistive heating can be used to heat the monolithic substrate to carbonize and/or active the monolithic substrate, as described herein below.

The monolithic substrate, the carbonized monolithic substrate, and the carbonized activated monolithic substrate, can include any suitable physical form. In various aspects, the physical form is that of a tubular form having a plurality of cells therein, the cells comprising parallel channels running longitudinally through the tubular form. The tubular form can have any suitable circumferential profile, such as that of a circle, oval, square, rectangle, polygon, or irregular shape. When viewed from an end of the tubular form, the cells can have any suitable shape, such as a honeycomb shape. The tubular form can include any suitable number of cells per square inch (e.g., as measured when viewed from an end), such as 50 to 400 cells per square inch, or 80 to 220, or less than or equal to 400 cells per square inch and greater than or equal to 50 squares per square inch, 60, 80, 100, 120, 140, 160, 180, 200, 220, 240, 260, 280, 300, 320, 340, 360, or 380 cells per square inch. The cells in the tubular form have any suitable wall thickness, such as a wall thickness of 0.001 inches to 0.02 inches, or 0.002 inches to 0.02 inches, 0.003 inches to 0.01 inches, or less than or equal to 0.02 inches or less than or equal to 0.01 inches and greater than or equal to 0.001 inches, 0.002, 0.003, 0.004, 0.005, 0.006, 0.007, 0.008, 0.009, 0.01, 0.011, 0.012, 0.013, 0.014, 0.015, 0.016, 0.017, 0.018, or 0.019 inches. In various aspects, the cells in the tubular form can include a geometry of 100/9.5, 100/7.5, 100/5.5, or 200/4 cells per square inch/0.001″ wall thickness.

The monolithic substrate can have any suitable open frontal area. The open frontal area is the percent cross-sectional surface area that is available for gas to flow therethrough. For example, the monolithic substrate can have an open frontal area of 80-95%, 80-90%, 90-95%, 85-95%, or less than 95% and greater than or equal to 80%, 81, 82, 83, 84, 85, 86, 87, 88, 89, 90, 91, 92, 93, or 94%.

The monolithic substrate, the carbonized monolithic substrate, and/or the carbonized and activated monolithic substrate can have any suitable geometric surface area. Geometric surface area is the total channel surface area per unit of substrate volume. The monolithic substrate, the carbonized monolithic substrate, and/or the carbonized and activated monolithic substrate can have a geometric surface area of 1.3 m²/L to 3 m²/L, 1.4 m²/L to 2.2 m²/L, or less than or equal to 3 m²/L and greater than or equal to 1.3 m²/L, 1.4, 1.5, 1.6, 1.7, 1.8, 1.9, 2, 2.1, 2.2, 2.3, 2.4, 2.5, 2.6, 2.7, 2.8, or 2.9 m²/L.

The monolithic substrate, the carbonized monolithic substrate, and/or the carbonized and activated monolithic substrate can have any suitable porosity, such as an open porosity of 0% to 5%, or 0% to 1%, or 40% to 90%, or 50% to 80%, or less than or equal to 90% and greater than or equal to 0%, 0.01, 0.05, 0.1, 0.2, 0.4, 0.6, 0.8, 1, 1.5, 2, 3, 4, 5, 6, 7, 8, 9, 10, 12, 14, 16, 18, 20, 25, 30, 32, 34, 36, 38, 40, 42, 44, 46, 48, 50, 52, 54, 56, 58, 60, 62, 64, 66, 68, 70, 72, 74, 76, 78, 80, 82, 84, 86, or 88%. As used herein, open porosity indicates the percentage void space not including internal pore volume, and indicates the total percentage of volume in the substrate available for gas to contact. Intact porous/hollow materials can result in low open porosity, while ruptured or broken porous and/or hollow materials or highly porous materials can result in high open porosity. In various aspects, the porous and/or hollow materials (e.g., hollow glass beads or hollow plastic beads) can be ruptured or broken via heating, such as heating during a carbonization and/or activation step.

The monolithic substrate, the carbonized monolithic substrate, and/or the carbonized and activated monolithic substrate can have any suitable maximum matrix volumetric heat capacity at 25° C. to 100° C., such as less than 140 kJ/kgK, or less than 100 kJ/kg/K, or equal to 50 kJ/kgK to 140 kJ/kgK, or 50 kJ/kgK to 100 kJ/kgK, or less than or equal to 140 kJ/kgK and greater than or equal to 50 kJ/kgK, 55, 60, 65, 70, 75, 80, 85, 90, 95, 100, 105, 110, 115, 120, 125, 130, or 135 kJ/kgK.

In various aspects, the monolithic substrate includes a high surface area material on the surface thereof. The high surface area material can be added to the monolithic substrate after the extrudable paste is dried and/or cured, before the extrudable paste is dried and/or cured, or a combination thereof. The high surface area material can be produced on the surface of the monolithic substrate via heating and/or via chemical reaction thereon.

In various aspects, the monolithic substrate includes a coating thereon, wherein the coating includes a material that adsorbs and desorbs CO₂. The material can be any suitable material that adsorbs and desorbs CO₂; for example, the material can include an amine-based sorbent (e.g., poly(ethylenimine)), a metal-organic framework (MOF), a carbon-based sorbent, a silica-based sorbent, an alumina-based sorbent, a zeolite-based sorbent, a porous crystalline solid sorbent, a metal oxide sorbent, or a combination thereof.

### Method of Making Monolithic Substrate.

Various aspects of the present invention provide a method of forming the monolithic substrate of the present invention. The method can include extruding the extrudable paste described herein that includes a hollow and/or porous material, and a binder, and that optionally includes a sorbent, sorbent aid, sorbent precursor, and/or sorbent aid precursor. The method can also include drying and/or curing the extruded extrudable paste.

The drying and/or curing can be any suitable drying or curing. The drying can include heating and/or allowing to dry. The curing can include heating. The drying and curing can occur during a single step, or the drying and the curing can be performed as discrete heating steps. In various aspects, the drying and/or curing includes heating at a temperature in a range of 50° C. to 400° C. (e.g., less than or equal to 400° C. and greater than or equal to 50° C., 60, 80, 100, 120, 140, 160, 180, 200, 220, 240, 260, 280, 300, 320, 340, 360, or 380° C.) for a duration of 1 min to 2 h (e.g., less than or equal to 2 h and greater than or equal to 1 min, 10, 20, 30, 40, 50 min, 1 h, 1.2, 1.4, 1.6, or 1.8 h).

The method can include coating a sorbent precursor, a sorbent, or a combination thereof, on an exterior surface of the extruded extrudable paste prior to the drying and/or curing.

The method can optionally include removing water-soluble components (e.g., optional cellulose derivatives such as methylcellulose and/or hydroxypropyl methylcellulose polymer), such as during the drying and/or curing, or as a separate treatment step.

### Method of Using Monolithic Substrate.

Various aspects of the present invention provide a method of using the monolithic substrate of the present invention. The method can include exposing monolithic substrate to a gas stream including CO₂ to at least partially adsorb the CO₂ from the gas stream into a coating on the monolithic substrate. The coating can include a material that adsorbs and desorbs CO₂. The method can also include desorbing the CO₂ from the coating on the monolithic substrate. In various aspects, desorbing the CO₂ from the coating on the monolithic substrate includes heating the monolithic substrate, such as by electrifying the monolithic substrate to cause resistive heating.

### Carbonized Monolithic Substrate.

Various aspects of the present invention provide a carbonized monolithic substrate that includes a carbonized product of the monolithic substrate of the present invention. The carbonized monolithic substrate includes a carbonized product of a monolithic substrate. The monolithic substrate includes a dried and/or cured product of an extruded extrudable paste. The extrudable paste can include a hollow and/or porous material. The extrudable paste can also include a binder. The monolithic substrate can have a bulk density of 60 g/L to 170 g/L.

The carbonized product cane be a product of heat treatment of the monolithic substrate, such as a product of heat treatment under an inert atmosphere. The carbonized product can be a product of heat treatment of the monolithic substrate under an inert atmosphere at 400° C. to 2000° C., 400° C. to 1200° C., or less than or equal to 2000° C. and greater than or equal to 400° C., 500, 600, 700, 800, 900, 1000, 1100, 1200, 1300, 1400, 1500, 1600, 1700, 1800, or 1900° C.

In various aspects, the carbonized monolithic substrate can be electrically conductive. The carbonized monolithic substrate can be electrically conductive such that the carbonized monolithic substrate can be resistively heated by flowing electricity through the carbonized monolithic substrate.

The carbonized monolithic substrate can further include a coating including a material that adsorbs and desorbs CO₂ gas. The material that adsorbs and desorbs CO₂ gas can be any suitable material; for example, the material can include an amine-based sorbent (e.g., poly(ethylenimine)), a metal-organic framework (MOF), a carbon-based sorbent, a silica-based sorbent, an alumina-based sorbent, a zeolite-based sorbent, a porous crystalline solid sorbent, a metal oxide sorbent, or a combination thereof.

The carbonized monolithic substrate can have any suitable bulk density. For example, the carbonized monolithic substrate can have a bulk density of 60 g/L to 170 g/L, 80 g/L to 140 g/L, 80 g/L to 120 g/L, or less than or equal to 170 g/L and greater than or equal to 60 g/L, 65, 70, 72, 74, 76, 78, 80, 82, 84, 86, 88, 90, 92, 94, 96, 98, 100, 102, 104, 106, 108, 110, 112, 114, 116, 118, 120, 122, 124, 126, 128, 130, or 135 g/L.

The carbonized monolithic substrate can have any suitable open frontal area. For example, the carbonized monolithic substrate can have an open frontal area of 80-95%, 80-90%, 90-95%, 85-95%, or less than 95% and greater than or equal to 80%, 81, 82, 83, 84, 85, 86, 87, 88, 89, 90, 91, 92, 93, or 94%.

Other properties of the carbonized monolithic substrate can be the same as the properties disclosed herein for the monolithic substrate, unless otherwise indicated.

### Method of Making Carbonized Monolithic Substrate.

In various aspects, the present invention provides a method of forming the carbonized monolithic substrate of the present invention. The method can include carbonizing the monolithic substrate of the present invention.

The carbonizing can include heating treating at a suitable temperature, such as under an inert atmosphere (e.g., argon). The carbonization can include heating under an inert atmosphere to a temperature in a range of 400° C. to 2000° C., 400° C. to 1200° C., or less than or equal to 2000° C. and greater than or equal to 400° C., 500, 600, 700, 800, 900, 1000, 1100, 1200, 1300, 1400, 1500, 1600, 1700, 1800, or 1900° C.

### Method of Using Carbonized Monolithic Substrate.

Various aspects of the present invention provide a method of using the carbonized monolithic substrate of the present invention. The method can include exposing carbonized monolithic substrate to a gas stream including CO₂ to at least partially adsorb the CO₂ from the gas stream into a coating on the carbonized monolithic substrate. The coating can include a material that adsorbs and desorbs CO₂. The method can include desorbing the CO₂ from the coating on the carbonized monolithic substrate. In various aspects, desorbing the CO₂ from the coating on the carbonized monolithic substrate includes heating the carbonized monolithic substrate, such as by electrifying the carbonized monolithic substrate to cause resistive heating.

### Carbonized and Activated Monolithic Substrate.

Various aspects of the present invention provide a carbonized and activated monolithic substrate that includes a carbonized and activated product of the monolithic substrate of the present invention. The carbonized and activated monolithic substrate includes a carbonized and activated product of a monolithic substrate. The monolithic substrate includes a dried and/or cured product of an extruded extrudable paste. The extrudable paste can include a hollow and/or porous material. The extrudable paste can also include a binder. The monolithic substrate can have a bulk density of 60 g/L to 170 g/L.

The carbonized and activated product can be a product of heat treatment of the monolithic substrate or the carbonized monolithic substrate, such as a product of heat treatment under an inert atmosphere, and/or in the presence of steam and/or CO₂. The carbonized and activated product can be a product of heat treatment of the monolithic substrate under an inert atmosphere at 400° C. to 2,000° C., or 400° C. to 1,200° C., followed by heat treatment in the presence of steam and/or CO₂ at a temperature of 500° C. to 1,500° C., or 500° C. to 1,200° C. The carbonized and activated product can be a product of heat treatment of the monolithic substrate under an inert atmosphere at 700° C. to 1,000° C., followed by heat treatment in the presence of steam and/or CO₂ at a temperature of 700° C. to 900° C.

The carbonized and activated monolithic substrate can have any suitable open porosity. For example, the carbonized and activated monolithic substrate can have an open porosity of 0% to 90%, or 0% to 1%, or 1% to 90%, or less than or equal to 90% and greater than or equal to 0%, 0.001, 0.005, 0.01, 0.05, 0.1, 0.2, 0.4, 0.6, 0.8, 0.9, 1, 1.1, 1.2, 1.3, 1.4, 1.5, 1.6, 1.8, 2, 4, 6, 8, 10, 15, 20, 25, 30, 35, 40, 45, 50, 55, 60, 65, 70, 75, 80, 82, 84, 86, or 88%. In various aspects, high open porosity can be achieved by the bursting or rupture of the hollow and/or porous material during carbonization and/or activation, and/or by the use of porous materials as the hollow and/or porous material.

The carbonized and activated monolithic substrate can have any suitable surface area, such as a surface area of 50 m²/g or more, or a surface area of 50 m²/g to 400 m²/g, or less than or equal to 400 m²/g and greater than or equal to 50 m²/g, 60, 80, 100, 120, 140, 160, 180, 200, 220, 240, 260, 280, 300, 320, 340, 360, 380 m²/g.

The carbonized and activated monolithic substrate can further including a coating including a material that adsorbs and desorbs CO₂ gas. The material that adsorbs and desorbs CO₂ gas can be any suitable material; for example, the material can include an amine-based sorbent (e.g., poly(ethylenimine)), a metal-organic framework (MOF), a carbon-based sorbent, a silica-based sorbent, an alumina-based sorbent, a zeolite-based sorbent, a porous crystalline solid sorbent, a metal oxide sorbent, or a combination thereof.

The carbonized and activated monolithic substrate can have any suitable bulk density. For example, the carbonized and activated monolithic substrate can have a bulk density of 60 g/L to 170 g/L, 80 g/L to 140 g/L, 80 g/L to 120 g/L, or less than or equal to 170 g/L and greater than or equal to 60 g/L, 65, 70, 72, 74, 76, 78, 80, 82, 84, 86, 88, 90, 92, 94, 96, 98, 100, 102, 104, 106, 108, 110, 112, 114, 116, 118, 120, 122, 124, 126, 128, 130, or 135 g/L.

The carbonized and activated monolithic substrate can have any suitable open frontal area. For example, the carbonized and activated monolithic substrate can have an open frontal area of 80-95%, 80-90%, 90-95%, 85-95%, or less than 95% and greater than or equal to 80%, 81, 82, 83, 84, 85, 86, 87, 88, 89, 90, 91, 92, 93, or 94%.

Other properties of the carbonized and activated monolithic substrate can be the same as the properties disclosed herein for the carbonized monolithic substrate and for the monolithic substrate, unless otherwise indicated.

### Method of Making Carbonized and Activated Monolithic Substrate.

In various aspects, the present invention provides a method of forming the carbonized and activated monolithic substrate of the present invention. The method can include activating the carbonized monolithic substrate of the present invention.

The activating can include heat treating at a suitable temperature, such as in the presence of a gas stream which can active or create additional surface area on the carbonized monolithic substrate, such as steam and/or CO₂. The activating can include heating in the presence of the gas stream such as steam and/or CO₂ to a temperature in a range of 500° C. to 1500° C., or 700° C. to 900° C., or less than or equal to 1500° C. and greater than or equal to 500° C., 550, 600, 650, 700, 750, 800, 850, 900, 950, 1000, 1050, 1100, 1150, 1200, 1250, 1300, 1350, 1400, or 1450° C. In various aspects, the heat treating can include electrifying the carbonized monolithic substrate to resistively heat the same by flowing electricity therethrough.

The method of forming the carbonized and activated monolithic substrate can also include adding a coating to the activated carbonized monolithic structure, wherein the coating includes a material that adsorbs and desorbs CO₂ gas. The coating can include any suitable material that adsorbs and desorbs CO₂ gas, such as an amine-based sorbent (e.g., poly(ethylenimine)), a metal-organic framework (MOF), a carbon-based sorbent, a silica-based sorbent, an alumina-based sorbent, a zeolite-based sorbent, a porous crystalline solid sorbent, a metal oxide sorbent, or a combination thereof).

### Method of Using Carbonized and Activated Monolithic Substrate.

Various aspects of the present invention provide a method of using the carbonized and activated monolithic substrate of the present invention. The method can include exposing the carbonized and activated monolithic substrate to a gas stream including CO₂ to at least partially adsorb the CO₂ from the gas stream into a coating on the carbonized and activated monolithic substrate. The coating can include a material that adsorbs and desorbs CO₂. The method can also include desorbing the CO₂ from the coating on the carbonized and activated monolithic substrate. In various aspects, desorbing the CO₂ from the coating on the carbonized and activated monolithic substrate includes heating the carbonized and activated monolithic substrate, such as by electrifying the carbonized and activated monolithic substrate to cause resistive heating.

The methods of using the monolithic substrate, carbonized monolithic substrate, and carbonized and activated monolithic substrate described herein can be used for any suitable method of CO₂-removal, such as direct air capture (DAC) or capture of CO₂ at an effluent source. The monolithic substrate, carbonized monolithic substrate, and carbonized and activated monolithic substrate described herein can be capable of withstanding temperatures of 200° C. or more and withstanding moist environments. In aspects of the monolithic substrate, carbonized monolithic substrate, and carbonized and activated monolithic substrate including a sorbent coating thereon, the sorbent coating can be substantially free of penetration into the substrate, such that the sorbent coating is an on-wall coating that gives increased or maximal contact with a gas passing thereby.

### EXAMPLES

Various aspects of the present invention can be better understood by reference to the following Examples which are offered by way of illustration. The present invention is not limited to the Examples given herein.

### Part I. Inert Substrate.

### Example 1-1. Hollow Glass Beads with Phenolic Resin

Two pastes were prepared using the recipes described in Table 1. The components were mixed together to form the pastes.

TABLE 1
Hollow glass beads with phenolic resin compositions.

| | | Recipe | Recipe |
|---|---|---|---|
| | | 1 | 2 |
| Hollow glass bead (ZKYL H60) with | g | 10 | 10 |
| D₅₀~50 microns | | | |
| Culminal 724 (methylcellulose derivative) | g | 2 | 2 |
| Sodium stearate (LIGA) | g | 0.2 | 0.2 |
| Water | g | 7 | 7 |
| Phenolic Resin GP510D50 | g | 18 | 9 |
| Estimated Resin Vol % After Curing | | 33% | 20% |

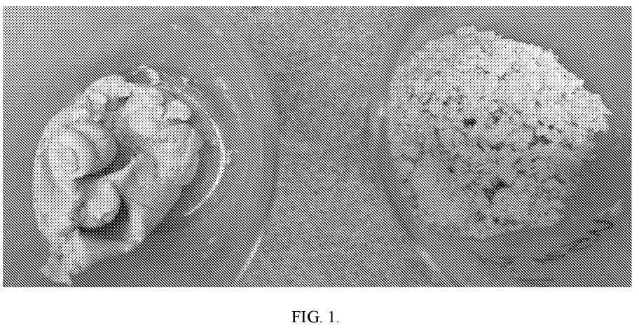

FIG. 1 illustrates a photograph of pastes made using Recipe 1 (left) and Recipe 2 (right). Both pastes were extrudable.

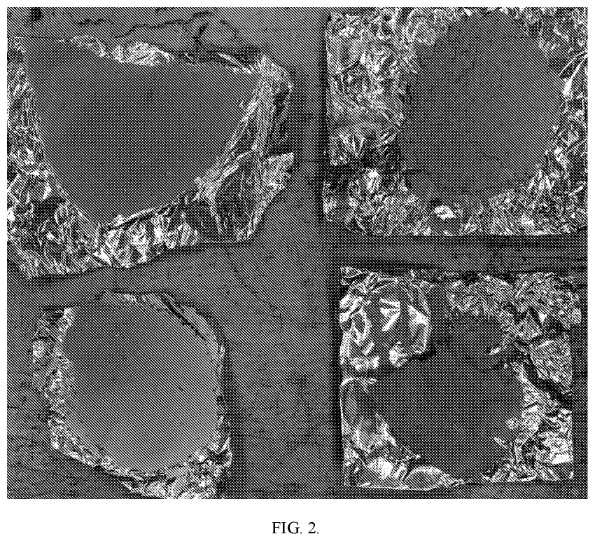

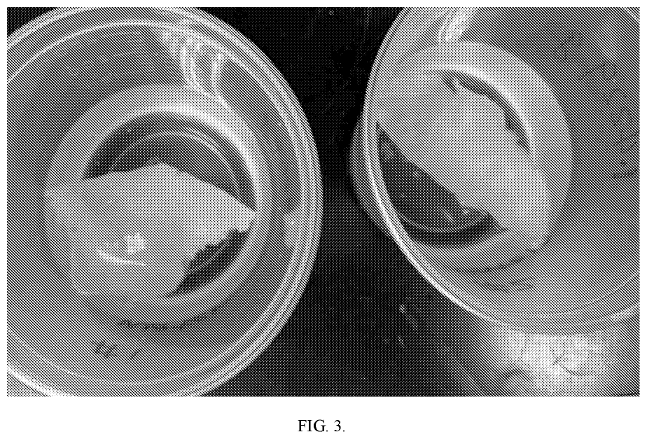

Each paste was hand rolled into sheets with two different thicknesses (˜0.7 mm and ˜2 mm) and then cured using the following thermal cycle: 85° C. for 30 min, 100° C. for 30 min, 150° C. for 30 min. FIG. 2 illustrates sheets rolled and cured from the two paste recipes, at the two different thicknesses, with the left sheets being formed from Recipe 1 and the right sheets being formed from Recipe 2, and with the top sheets being ˜2 mm thickness and the bottom sheets being ˜0.7 mm thickness. The cured sheets were rigid and mechanically strong. FIG. 3 illustrates rolled and cured sheets prepared from Recipe 1 (left) and Recipe 2 (right) floating in water, indicating that the specific gravity of the rolled and cured sheets was less than 1.

The samples shown in FIG. 3 were allowed to float in water for 12 days and then removed and dried at 150° C. for 40 minutes. The two samples lost 3.3% (Recipe 1) and 3.6% (Recipe 2) of the original cured weight, presumably due to leaching of Culminal 724 and/or LIGA. However, they remained intact and mechanically strong.

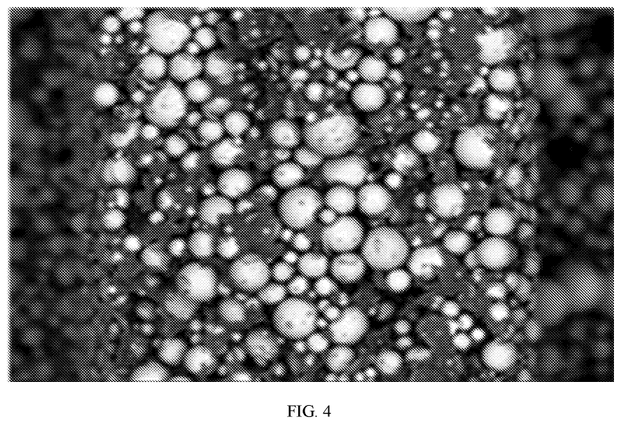

FIG. 4 illustrates a scanning electron microscope (SEM) image showing a cross-section of the rolled and cured sheet made using a recipe identical to Recipe 1 but lacking the phenolic resin.

### Example 1-2. Hollow Polymer Beads with Phenolic Resin

Example 1 was performed again but using hollow polymer beads in place of the hollow glass beads. The pastes formed were extrudable, and could be cured and rolled to form rigid and mechanically strong sheets that float in water.

### Part II. Sorbent-Ready Substrates.

### Example 2-1. Hollow Glass Beads with Phenolic Resin, Pyrolyzed and Activated

The pastes from Example 1-1 are extruded into a monolithic honeycomb structure and are cured using the same protocol described in Example 1-1. The extruded cured pasted are then carbonized in an inert atmosphere (e.g., N₂ or Ar) at a temperature in the range of 700° C. to 1000° C. for 1 h, and then activated in steam or CO₂ at a temperature in the range of 700° C. to 900° C. for 1 h to obtain high surface area. The curing, carbonization and activation steps can be run as separate processes or integrated as multiple phases of a single process.

The mass and thermal mass of the cured, carbonized, activated monolithic forms are less than the same properties for a cordierite honeycomb structure having the same physical form.

### Example 2-2. Hollow Glass Beads with Phenolic Resin and Al₂O₃ Precursor, Pyrolyzed and Activated

Example 2-2 is repeated, but the paste also includes alumina precursors such as an aluminum alkoxide (e.g., aluminum isopropoxide), and/or alumina particles, with a ratio of alumina precursor and/or alumina to hollow glass beads in an amount of 1:10 to 1:1 by weight.

The mass and thermal mass of the cured, carbonized, activated monolithic forms are less than the same properties for a cordierite honeycomb structure having the same physical form.

### Example 2-3. Hollow Glass Beads with Phenolic Resin and TiO₂ Precursor, Pyrolyzed and Activated

Example 2-2 is repeated, but the pastes used to make the monolithic forms also include titania precursors such as a titanium alkoxide (e.g., titanium isopropoxide or titanium butoxide), and/or titania particles, with a ratio of titania precursor and/or titania to hollow glass beads in an amount of 1:10 to 1:1 by weight.

The mass and thermal mass of the cured, carbonized, activated monolithic forms are less than the same properties for a cordierite honeycomb structure having the same physical form.

### Example 2-4. Hollow Glass Beads with Phenolic Resin and SiO₂ Precursor, Pyrolyzed and Activated

Example 2-2 is repeated, but the pastes used to make the monolithic forms also include SiO₂ precursors such as an alkoxysilane (e.g., tetraethoxysilane or tetrabutoxysilane), and/or silica particles, with a ratio of silica precursor and/or silica to hollow glass beads in an amount of 1:10 to 1:1 by weight.

The mass and thermal mass of the cured, carbonized, activated monolithic forms are less than the same properties for a cordierite honeycomb structure having the same physical form.

Table 2 illustrates properties of reference and inventive materials and substrates. GSA is geometric surface area, and OFA is open frontal area (the clear cross-section surface available for flow therethrough). Geometry is 100/7.5 unless otherwise indicated.

TABLE 2
Properties of reference and inventive materials and substrates.

| Material | Open | Bulk | | |
|---|---|---|---|---|
| (assuming a 100/7.5 geometry | Porosity | den. | GSA | OFA |
| unless otherwise noted) | (%) | (g/liter) | (m²/liter) | (%) |
| Standard cordierite (EX-26) | 32 | 260 | 1.44 | 85.6 |
| High porosity cordierite | 55 | 172 | 1.44 | 85.6 |
| Higher porosity cordierite | 65 | 134 | 1.44 | 85.6 |
| High porosity glass | 70 | 95 | 1.44 | 85.6 |
| Example 1-1, Recipe 1, | Negligible | 127 | 1.44 | 85.6 |
| extruded and cured. | | | | |
| Example 1-1, Recipe 2, | Negligible | 115 | 1.44 | 85.6 |
| extruded and cured. | | | | |
| Example 2-1 extruded, cured, | TBD | TBD | 1.44 | 85.6 |
| carbonized, and activated | | | | |
| Example 1-1, Recipe 2, | Negligible | 85 | 1.49 | 89.3 |
| extruded and cured with 100/5.5 | | | | |
| geometry | | | | |
| Example 1-1, Recipe 2, | Negligible | 87 | 2.10 | 89.0 |
| extruded and cured with 200/4.0 | | | | |
| geometry | | | | |

### Example 2-5. Hollow Glass Beads with Phenolic Resin and Extrusion into Honeycombs, and Carbonization Thereof at 400° C., 800° C., and 970° C.

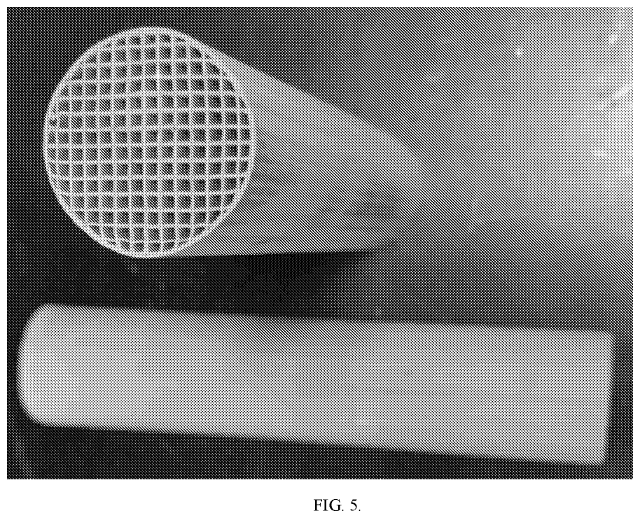

Recipe 1 from Example 1-1 was scaled up by a factor of 50×, weighed and mixed in a ProcessAll mixer. The paste was successfully extruded through a 1″ diameter 200/12 die on a small ram extruder. The extruded honeycombs were cured at 150° C. for 1 hour. The cured honeycombs became mechanically strong. A photograph of the extruded honeycombs, showing a top and side view, is shown in FIG. 5.

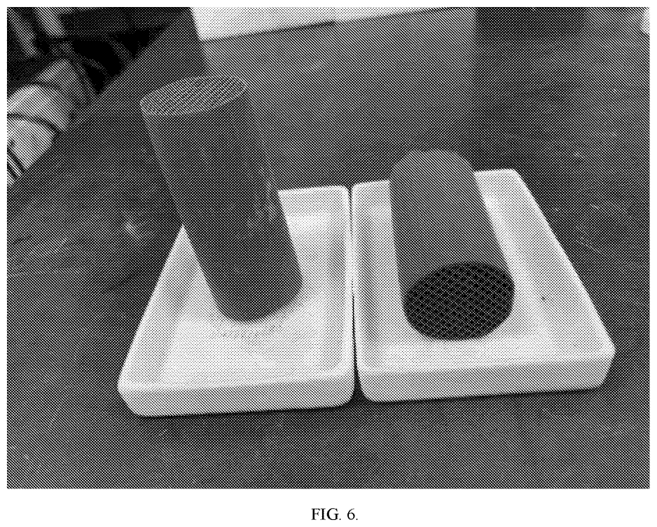

Two of the cured honeycombs were carbonized at 400° C. under an N₂ atmosphere. A photograph illustrating side and top views of the cured and carbonized honeycombs is shown in FIG. 6. The weight loss from carbonization was ˜11% and the estimated carbon yield was ˜76%.

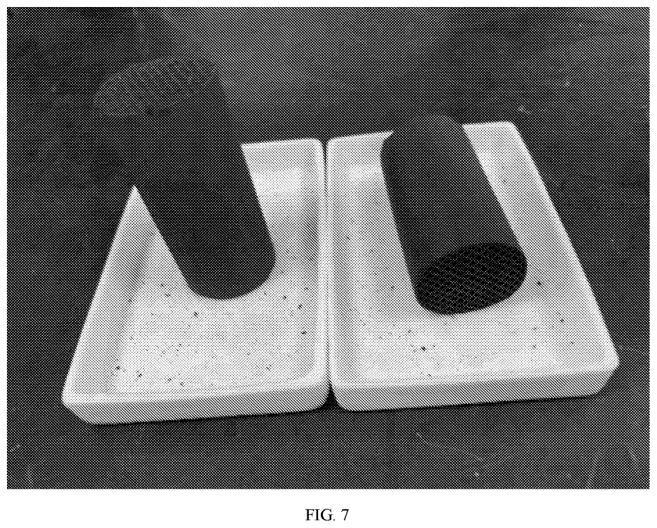

Two of the cured honeycombs were carbonized at 800° C. under an N₂ atmosphere. A photograph illustrating side and top view of the cured and carbonized honeycombs is shown in FIG. 7. Weight loss from carbonization was ˜23.2% and the estimated carbon yield was 48.5%. Carbonization on another cured honeycomb was also performed at 970° C. under an N₂ atmosphere (not shown).

The honeycombs are expected to be thermally conductive. The honeycombs carbonized at 800° C. and 970° C. were measured to be electrically conductive.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### EXEMPLARY ASPECTS

The following exemplary aspects are provided, the numbering of which is not to be construed as designating levels of importance:

Aspect 1 provides a monolithic substrate comprising:
a dried and/or cured product of an extruded extrudable paste, the extrudable paste comprising
   a hollow and/or porous material, and
   a binder;
wherein the monolithic substrate has a bulk density of 60 g/L to 170 g/L.

Aspect 2 provides the monolithic substrate of Aspect 1, wherein the dried and/or cured product of the extruded extrudable paste is a dried product of the extruded extrudable paste.

Aspect 3 provides the monolithic substrate of any one of Aspects 1-2, wherein the dried and/or cured product of the extruded extrudable paste is a cured product of the extruded extrudable paste.

Aspect 4 provides the monolithic substrate of any one of Aspects 1-3, wherein the dried and/or cured product of the extruded extrudable paste is a dried and cured product of the extruded extrudable paste.

Aspect 5 provides the monolithic substrate of any one of Aspects 1-4, wherein the monolithic substrate has a bulk density of 80 g/L to 140 g/L.

Aspect 6 provides the monolithic substrate of any one of Aspects 1-5, wherein the monolithic substrate has a bulk density of 80 g/L to 120 g/L.

Aspect 7 provides the monolithic substrate of any one of Aspects 1-6, wherein the extrudable paste has a bulk density of less than 1000 g/L.

Aspect 8 provides the monolithic substrate of any one of Aspects 1-7, wherein when extruded horizontally into a shape of the monolithic substrate, the extrudable paste spans a gap having a distance in a range of 0.1 m to 10 m without slumping or deforming.

Aspect 9 provides the monolithic substrate of any one of Aspects 1-8, wherein the dried and/or cured product of the extruded extrudable paste is conductive.

Aspect 10 provides the monolithic substrate of any one of Aspects 1-9, wherein the hollow and/or porous material comprises paper, polymer, glass, glass ceramic, ceramic, or a combination thereof.

Aspect 11 provides the monolithic substrate of any one of Aspects 1-10, wherein the hollow and/or porous material is a particulate material having a particle size of 0.1 microns to 500 microns, or 0.1 microns to 100 microns.

Aspect 12 provides the monolithic substrate of Aspect 11, wherein the particulate material has a particle size of 10 microns to 200 microns.

Aspect 13 provides the monolithic substrate of any one of Aspects 1-12, wherein the hollow and/or porous material is hollow glass beads, hollow plastic beads, hollow glass ceramic beads, hollow ceramic beads, cenospheres, fly ash-based hollow beads, or a combination thereof.

Aspect 14 provides the monolithic substrate of any one of Aspects 1-13, further comprising a sorbent and/or sorbent aid.

Aspect 15 provides the monolithic substrate of Aspect 14, wherein the extrudable paste comprises the sorbent and/or sorbent aid as a homogeneous mixture therewith.

Aspect 16 provides the monolithic substrate of any one of Aspects 14-15, wherein the sorbent and/or sorbent aid is added after curing and/or drying of the extruded extrudable paste.

Aspect 17 provides the monolithic substrate of any one of Aspects 14-16, wherein the sorbent aid comprises Al₂O₃, TiO₂, SiO₂, or a combination thereof, and wherein the sorbent comprises a zeolite, sodium carbonate, activated carbon, carbon nanotubes, a metal-organic framework (MOF), an amine, or a combination thereof.

Aspect 18 provides the monolithic substrate of any one of Aspects 1-17, further comprising a sorbent precursor and/or sorbent aid precursor.

Aspect 19 provides the monolithic substrate of Aspect 18, wherein the extrudable paste comprises the sorbent precursor and/or sorbent aid precursor as a homogeneous mixture therewith.

Aspect 20 provides the monolithic substrate of any one of Aspects 18-19, wherein the sorbent precursor and/or sorbent aid precursor is added after curing and/or drying of the extruded extrudable paste.

Aspect 21 provides the monolithic substrate of any one of Aspects 18-20, wherein the sorbent precursor and/or sorbent aid precursor comprises an Al₂O₃ precursor, a TiO₂ precursor, an SiO₂ precursor, or a combination thereof.

Aspect 22 provides the monolithic substrate of any one of Aspects 18-21, wherein the sorbent precursor and/or sorbent aid precursor comprises an aluminum alkoxide, a titanium alkoxide, an alkoxysilane, or a combination thereof.

Aspect 23 provides the monolithic substrate of any one of Aspects 18-22, wherein the sorbent precursor and/or sorbent aid precursor comprises aluminum isopropoxide, titanium isopropoxide, titanium butoxide, tetraethoxysilane, tetrabutoxysilane, or a combination thereof.

Aspect 24 provides the monolithic substrate of any one of Aspects 18-23, wherein a mass ratio of the sorbent precursor and/or sorbent aid precursor to the hollow and/or porous material is 0.01:1 to 2:1 by weight.

Aspect 25 provides the monolithic substrate of any one of Aspects 18-24, wherein a mass ratio of the sorbent precursor and/or sorbent aid precursor to the hollow and/or porous material is 0.1:1 to 1:1 by weight.

Aspect 26 provides the monolithic substrate of any one of Aspects 1-25, wherein the binder comprises an inorganic binder, a polymer, a thermosetting resin, or a combination thereof.

Aspect 27 provides the monolithic substrate of any one of Aspects 1-26, wherein the binder comprises a phenolic resin.

Aspect 28 provides the monolithic substrate of any one of Aspects 1-27, wherein the monolithic substrate comprises a honeycomb shape.

Aspect 29 provides the monolithic substrate of Aspect 28, wherein the honeycomb shape comprises 50 to 400 cells per square inch.

Aspect 30 provides the monolithic substrate of any one of Aspects 28-29, wherein the honeycomb shape comprises 80 to 220 cells per square inch.

Aspect 31 provides the monolithic substrate of any one of Aspects 28-30, wherein the honeycomb shape comprises a wall thickness of 0.001 inches to 0.02 inches.

Aspect 32 provides the monolithic substrate of any one of Aspects 28-31, wherein the honeycomb shape comprises a wall thickness of 0.003 inches to 0.01 inches.

Aspect 33 provides the monolithic substrate of any one of Aspects 28-32, wherein the honeycomb shape comprises a geometry of 100/9.5, 100/7.5, 100/5.5, or 200/4 cells per square inch/0.001″ wall thickness.

Aspect 34 provides the monolithic substrate of any one of Aspects 1-33, wherein the monolithic substrate has an open frontal area of 80-95%.

Aspect 35 provides the monolithic substrate of any one of Aspects 1-34, wherein the monolithic substrate has a geometric surface area of 1.3 m²/L to 3 m²/L.

Aspect 36 provides the monolithic substrate of any one of Aspects 1-35, wherein the monolithic substrate has a geometric surface area of 1.4 m²/L to 2.2 m²/L.

Aspect 37 provides the monolithic substrate of any one of Aspects 1-36, wherein the monolithic substrate has an open porosity of 0% to 5%.

Aspect 38 provides the monolithic substrate of any one of Aspects 1-37, wherein the monolithic substrate has an open porosity of 0% to 1%.

Aspect 39 provides the monolithic substrate of any one of Aspects 1-38, wherein the monolithic substrate has an open porosity of 40% to 90%.

Aspect 40 provides the monolithic substrate of any one of Aspects 1-39, wherein the monolithic substrate has an open porosity of 50% to 80%.

Aspect 41 provides the monolithic substrate of any one of Aspects 1-40, wherein the dried and/or cured product of the extruded extrudable paste is a product of heat treatment at 50° C. to 400° C. for 1 min to 2 h.

Aspect 42 provides the monolithic substrate of any one of Aspects 1-41, further comprising a high surface area material on the surface thereof.

Aspect 43 provides the monolithic substrate of any one of Aspects 1-42, further comprising a coating thereon, the coating comprising a material that adsorbs and desorbs CO₂.

Aspect 44 provides a monolithic substrate comprising:
a dried and cured product of an extruded extrudable paste, the extrudable paste comprising
   a hollow and/or porous material comprising hollow glass beads, hollow plastic beads, hollow glass ceramic beads, hollow ceramic beads, cenospheres, fly ash-based hollow beads, or a combination thereof, and
   a binder comprising a polymer, an inorganic binder, a thermosetting resin, or a combination thereof;
wherein the monolithic substrate has a bulk density of 60 g/L to 170 g/L and an open frontal area of 80-95%.

Aspect 45 provides a carbonized monolithic substrate comprising a carbonized product of the monolithic substrate of any one of Aspects 1-44.

Aspect 46 provides the carbonized monolithic substrate of Aspect 45, wherein the carbonized monolithic substrate is electrically conductive.

Aspect 47 provides the carbonized monolithic substrate of any one of Aspects 45-46, further comprising a coating comprising a material that adsorbs and desorbs CO₂ gas.

Aspect 48 provides the carbonized monolithic substrate of any one of Aspects 45-47, wherein the product of carbonization is a product of heat treatment under an inert atmosphere at 400° C. to 2000° C.

Aspect 49 provides the carbonized monolithic substrate of any one of Aspects 45-48, wherein the product of carbonization is a product of heat treatment under an inert atmosphere at 400° C. to 1200° C.

Aspect 50 provides a carbonized monolithic substrate comprising:
a dried, cured, and carbonized product of an extruded extrudable paste, the extrudable paste comprising
   a hollow and/or porous material comprising hollow glass beads, hollow plastic beads, hollow glass ceramic beads, hollow ceramic beads, cenospheres, fly ash-based hollow beads, or a combination thereof, and
   a binder comprising a polymer, an inorganic binder, a thermosetting resin, or a combination thereof;
wherein the carbonized monolithic substrate has a bulk density of 60 g/L to 170 g/L and an open frontal area of 80-95%.

Aspect 51 provides a carbonized and activated monolithic substrate comprising a carbonized and activated product of the monolithic substrate of any one of Aspects 1-44.

Aspect 52 provides the carbonized and activated monolithic substrate of

Aspect 51, wherein the product of carbonization and activation is a product of heat treatment under an inert atmosphere at 400° C. to 2,000° C. and heat treatment in the presence of steam and/or CO₂ at a temperature of 500° C. to 1,500° C., or is a product of heat treatment under an inert atmosphere at 400° C. to 1,200° C. and heat treatment in the presence of steam and/or CO₂ at a temperature of 500° C. to 1,200° C.

Aspect 53 provides the carbonized and activated monolithic substrate of any one of Aspects 51-52, wherein the product of carbonization and activation is a product of heat treatment under an inert atmosphere at 700° C. to 1,000° C. and heat treatment in the presence of steam and/or CO₂ at a temperature of 700° C. to 900° C.

Aspect 54 provides the carbonized and activated monolithic substrate of any one of Aspects 51-53, wherein the carbonized and activated monolithic substrate has an open porosity of 0% to 1%.

Aspect 55 provides the carbonized and activated monolithic substrate of any one of Aspects 51-54, wherein the carbonized and activated monolithic substrate has an open porosity of 1% to 90%.

Aspect 56 provides the carbonized and activated monolithic substrate of any one of Aspects 51-55, further comprising a coating comprising a material that adsorbs and desorbs CO₂ gas.

Aspect 57 provides the carbonized and activated monolithic substrate of Aspect 56, wherein the coating comprises a poly(ethylenimine).

Aspect 58 provides the carbonized and activated monolithic substrate of any one of Aspects 51-57, wherein the carbonized and activated monolithic substrate has a surface area of 50 m²/g to 400 m²/g.

Aspect 59 provides a carbonized and activated monolithic substrate comprising:
a dried, cured, carbonized, and activated product of an extruded extrudable paste, the extrudable paste comprising
   a hollow and/or porous material comprising hollow glass beads, hollow plastic beads, hollow glass ceramic beads, hollow ceramic beads, cenospheres, fly ash-based hollow beads, or a combination thereof,
   a binder comprising a polymer, an inorganic binder, a thermosetting resin, or a combination thereof, and
   a sorbent, a sorbent aid, a sorbent precursor, and/or a sorbent aid precursor, the sorbent aid comprising Al₂O₃, TiO₂, SiO₂, or a combination thereof, the sorbent comprising a zeolite, sodium carbonate, activated carbon, carbon nanotubes, a metal-organic framework (MOF), an amine, or a combination thereof, and the sorbent precursor and/or sorbent aid precursor comprising an Al₂O₃ precursor, a TiO₂ precursor, an SiO₂ precursor, or a combination thereof;
wherein the carbonized and activated monolithic substrate has a bulk density of 60 g/L to 170 g/L and an open frontal area of 80-95%.

Aspect 60 provides a method of forming the monolithic substrate of any one of Aspects 1-44, the method comprising:
extruding the extrudable paste; and
drying and/or curing the extruded extrudable paste.

Aspect 61 provides the method of Aspect 60, further comprising coating a sorbent precursor and/or sorbent aid precursor on an exterior surface of the extruded extrudable paste prior to the curing.

Aspect 62 provides the method of any one of Aspects 60-61, further comprising coating a sorbent and/or sorbent aid on an exterior surface of the extruded extrudable paste after the curing.

Aspect 63 provides the method of any one of Aspects 60-62, wherein the curing and/or drying comprises heating at a temperature in a range of 50° C. to 400° C. for a duration of 1 min to 2 h.

Aspect 64 provides a method of forming the carbonized monolithic substrate of any one of Aspects 45-50, the method comprising:
carbonizing the monolithic substrate of any one of Aspects 1-44.

Aspect 65 provides the method of Aspect 64, wherein the carbonization comprises heat treating under an inert atmosphere at 400° C. to 2000° C., or 400° C. to 1200° C.

Aspect 66 provides the method of any one of Aspects 64-65, wherein the carbonization comprises heat treating under an inert atmosphere at 400° C. to 1200° C.

Aspect 67 provides a method of forming the carbonized and activated monolithic substrate of any one of Aspects 51-59, the method comprising:

activating the carbonized monolithic substrate of any one of Aspects 45-50.

Aspect 68 provides the method of Aspect 67, wherein the activation comprises heat treatment in the presence of steam and/or CO₂ at a temperature of 500° C. to 1,500° C.

Aspect 69 provides the method of any one of Aspects 67-68, wherein the activation comprises heat treatment in the presence of steam and/or CO₂ at a temperature of 700° C. to 900° C.

Aspect 70 provides the method of any one of Aspects 67-69, wherein the activation comprises electrifying the carbonized monolithic substrate to resistively heat the same.

Aspect 71 provides the method of any one of Aspects 67-70, further comprising adding a coating to the activated carbonized monolithic structure, the coating comprising a material that adsorbs and desorbs CO₂ gas.

Aspect 72 provides the method of Aspect 71, wherein the coating comprises a poly(ethylenimine).

Aspect 73 provides a method of using the monolithic substrate of any one of Aspects 1-44, the method comprising:
exposing monolithic substrate to a gas stream comprising CO₂ to at least partially adsorb the CO₂ from the gas stream into a coating on the monolithic substrate, the coating comprising a material that adsorbs and desorbs CO₂; and
desorbing the CO₂ from the coating on the monolithic substrate.

Aspect 74 provides a method of using the carbonized monolithic substrate of any one of Aspects 45-50, the method comprising:
exposing carbonized monolithic substrate to a gas stream comprising CO₂ to at least partially adsorb the CO₂ from the gas stream into a coating on the carbonized monolithic substrate, the coating comprising a material that adsorbs and desorbs CO₂; and
desorbing the CO₂ from the coating on the carbonized monolithic substrate.

Aspect 75 provides a method of using the carbonized and activated monolithic substrate of any one of Aspects 51-59, the method comprising:
exposing carbonized and activated monolithic substrate to a gas stream comprising CO₂ to at least partially adsorb the CO₂ from the gas stream into a coating on the carbonized and activated monolithic substrate, the coating comprising a material that adsorbs and desorbs CO₂; and
desorbing the CO₂ from the coating on the carbonized and activated monolithic substrate.

Aspect 76 provides the monolithic substrate, carbonized monolithic substrate, carbonized and activated monolithic substrate, or method of any one or any combination of Aspects 1-75 optionally configured such that all elements or options recited are available to use or select from.

Aspect 76 provides the monolithic substrate, carbonized monolithic substrate, carbonized and activated monolithic substrate, or method of any one or any combination of Aspects 1-75, wherein the monolithic substrate, carbonized monolithic substrate, or carbonized and activated monolithic substrate has a maximum matrix volumetric heat capacity of less than 140 kJ/kgK at 25° C. to 100° C.

Aspect 76 provides the monolithic substrate, carbonized monolithic substrate, carbonized and activated monolithic substrate, or method of any one or any combination of Aspects 1-75, wherein the monolithic substrate, carbonized monolithic substrate, or carbonized and activated monolithic substrate has a maximum matrix volumetric heat capacity of less than 100 kJ/kgK at 25° C. to 100° C.

What is claimed is:

1. A monolithic substrate comprising:
a dried and/or cured product of an extruded extrudable paste, the extrudable paste comprising
a hollow and/or porous material, and
a binder;
wherein the monolithic substrate has a bulk density of 60 g/L to 170 g/L and an open frontal area of 80-95%.

2. The monolithic substrate of claim 1, wherein the hollow and/or porous material is hollow glass beads, hollow plastic beads, hollow glass ceramic beads, hollow ceramic beads, cenospheres, fly ash-based hollow beads, or a combination thereof, wherein the particulate material has a particle size of 0.1 microns to 100 microns.

3. The monolithic substrate of claim 1, further comprising a sorbent, a sorbent aid, a sorbent precursor, a sorbent aid precursor, or a combination thereof.

4. The monolithic substrate of claim 3, wherein
the sorbent comprises a zeolite, sodium carbonate, activated carbon, carbon nanotubes, a metal-organic framework (MOF), an amine, or a combination thereof;
the sorbent aid comprises Al₂O₃, TiO₂, SiO₂, or a combination thereof; and
the sorbent precursor and/or sorbent aid precursor comprises an Al₂O₃ precursor, a TiO₂ precursor, an SiO₂ precursor, or a combination thereof.

5. The monolithic substrate of claim 1, wherein the binder comprises an inorganic binder, a polymer, a thermosetting resin, or a combination thereof.

6. The monolithic substrate of claim 1, wherein the monolithic substrate comprises a honeycomb shape, wherein the honeycomb shape comprises 50 to 400 cells per square inch and a wall thickness of 0.001 inches to 0.02 inches.

7. The monolithic substrate of claim 1, further comprising a coating thereon, the coating comprising a material that adsorbs and desorbs CO₂.

8. A carbonized monolithic substrate comprising a carbonized product of the monolithic substrate of claim 1, wherein the product of carbonization is a product of heat treatment under an inert atmosphere at 400° C. to 1200° C.

9. A carbonized monolithic substrate comprising:
a dried, cured, and carbonized product of an extruded extrudable paste, the extrudable paste comprising
a hollow and/or porous material comprising hollow glass beads, hollow plastic beads, hollow glass ceramic beads, hollow ceramic beads, cenospheres, fly ash-based hollow beads, or a combination thereof, and
a binder comprising a polymer, an inorganic binder, a thermosetting resin, or a combination thereof:
wherein the carbonized monolithic substrate has a bulk density of 60 g/L to 170 g/L and an open frontal area of 80-95%.

10. A carbonized and activated monolithic substrate comprising a carbonized and activated product of the monolithic substrate of claim 1.

11. The carbonized and activated monolithic substrate of claim 10, further comprising a coating comprising a material that adsorbs and desorbs CO₂ gas.

12. A carbonized and activated monolithic substrate comprising:
a dried, cured, carbonized, and activated product of an extruded extrudable paste, the extrudable paste comprising
a hollow and/or porous material comprising hollow glass beads, hollow plastic beads, hollow glass ceramic beads, hollow ceramic beads, cenospheres, fly ash-based hollow beads, or a combination thereof,
a binder comprising a polymer, an inorganic binder, a thermosetting resin, or a combination thereof, and
a sorbent, sorbent aid, sorbent precursor, and/or sorbent aid precursor, the sorbent aid comprising Al₂O₃, TiO₂, SiO₂, or a combination thereof, the sorbent comprising a zeolite, sodium carbonate, activated carbon, carbon nanotubes, a metal-organic framework (MOF), an amine, or a combination thereof, and the sorbent precursor and/or sorbent aid precursor comprising an Al₂O₃ precursor, a TiO₂ precursor, an SiO₂ precursor, or a combination thereof:
wherein the carbonized and activated monolithic substrate has a bulk density of 60 g/L to 170 g/L, an open frontal area of 80-95%, and a surface area of 50 m²/g to 400 m²/g.

13. The monolithic substrate of claim 1, the carbonized monolithic substrate of any one of claims 8-9, or the carbonized activated monolithic substrate of any one of claims 10-12, wherein the carbonized monolithic substrate, carbonized monolithic substrate, or carbonized activated monolithic substrate has a maximum matrix volumetric heat capacity of less than 140 kJ/kgK at 25° C. to 100° C.

14. The carbonized monolithic substrate of claim 1, or the carbonized activated monolithic substrate of any one of claims 10-13, wherein the carbonized monolithic substrate or the carbonized activated monolithic substrate is electrically conductive.

15. A method of forming the monolithic substrate of claim 1, the method comprising:
extruding the extrudable paste; and
drying and/or curing the extruded extrudable paste, wherein the curing and/or drying comprises heating at a temperature in a range of 50° C. to 400° C. for a duration of 1 min to 2 h.

16. A method of forming the carbonized monolithic substrate of claim 1, the method comprising:
carbonizing the monolithic substrate of any one of claim 1-7 or 13, wherein the carbonization comprises heat treating under an inert atmosphere at 400° C. to 1200° C.

17. A method of forming the carbonized and activated monolithic substrate of claim 1, the method comprising:
activating the carbonized monolithic substrate of any one of claim 8-9 or 13, wherein the activation comprises heat treatment in the presence of steam and/or CO₂ at a temperature of 500° C. to 1,500° C.

18. The method of claim 17, wherein the activation comprises electrifying the carbonized monolithic substrate to resistively heat the same.

19. The method of claim 1, further comprising adding a coating to the activated carbonized monolithic structure, the coating comprising a material that adsorbs and desorbs CO₂ gas.

20. A method of using the monolithic substrate of claim 1, the method comprising:
exposing the monolithic substrate to a gas stream comprising CO₂ to at least partially adsorb the CO₂ from the gas stream into a coating on the monolithic substrate, the coating comprising a material that adsorbs and desorbs CO₂; and
desorbing the CO₂ from the coating on the monolithic substrate.

21. A method of using the carbonized substrate of claim 8, the method comprising:
exposing the carbonized monolithic substrate to a gas stream comprising CO₂ to at least partially adsorb the CO₂ from the gas stream into a coating on the carbonized monolithic substrate, the coating comprising a material that adsorbs and desorbs CO₂; and
desorbing the CO₂ from the coating on the carbonized monolithic substrate.

22. A method of using the carbonized and activated monolithic substrate of claim 10, the method comprising:
exposing carbonized and activated monolithic substrate to a gas stream comprising CO₂ to at least partially adsorb the CO₂ from the gas stream into a coating on the carbonized and activated monolithic substrate, the coating comprising a material that adsorbs and desorbs CO₂; and
desorbing the CO₂ from the coating on the carbonized and activated monolithic substrate.

23. The method of claim 21, wherein the carbonized substrate or carbonized and activated monolithic substrate is electrically conductive, wherein the desorbing of the CO₂ comprises resistively heating the carbonized substrate or carbonized and activated monolithic substrate.
